(19) United States
(12) Patent Application Publication
(10) Pub. No.: US 2007/0024893 A1
(43) Pub. Date: Feb. 1, 2007

(54) Image forming system, information processing apparatus, and image forming apparatus

(76) Inventor: Takaaki Hosoda, Tokyo (JP)

Correspondence Address: RABIN & Berdo, PC, 1101 14TH STREET, NW, SUITE 500, WASHINGTON, DC, 20005, US

(21) Appl. No.: 11/493,590

(22) Filed: Jul. 27, 2006

(30) Foreign Application Priority Data
Jul. 29, 2005 (JP) 2005-221409

(51) Int. Cl. G06K 15/00

(52) U.S. Cl. 358/1.14

(57) ABSTRACT

An image forming system includes an information processing apparatus and an image forming apparatus. A user registers biometric information at the information processing apparatus. When the user subsequently gives a printing command at the information processing apparatus, print data and the registered biometric information are sent to the image forming apparatus but the print data are not printed until the user enters matching biometric information at the image forming apparatus. This scheme prevents unwanted people from seeing the printed output, without requiring the user to register biometric data at the image forming apparatus, carry an identification card, or remember a password. The biometric information may also be used to encrypt the print data.

### BACKGROUND OF THE INVENTION

1. Field of the Invention

The present invention relates to an image forming system comprising an information processing apparatus and an image forming apparatus, more particularly to an image forming system with an improved security scheme for preventing people other than the information processing apparatus user who gives a printing command from seeing the printed image.

2. Description of the Related Art

In image forming systems comprising an information processing apparatus such as a computer and an image forming apparatus such as a printer linked by a communication network, the image forming apparatus is often located at some distance from the information processing apparatus, so that it takes some time for a user of the information processing apparatus who gives a printing command to go to the image forming apparatus to fetch the printed image. During this time, another person using the image forming apparatus may see confidential information in the printed image.

To avoid this situation, some conventional security-conscious image forming systems use a personal identification card (ID card) or a combination of an ID card and a personal identification number (PIN) to identify the user before the image forming apparatus starts printing.

Another scheme, described in Japanese Patent Application Publication No. 2000-177211, obtains a user's password or PIN before sending print data from the information processing apparatus to the image forming apparatus, and sends the password (or PIN) together with the print data. The image forming apparatus does not immediately print the data it receives, but stores the print data and password temporarily in an internal memory until the user arrives at the image forming apparatus and enters the password. When the password is entered, the image forming apparatus reads the print data from its memory and starts printing.

In conventional image forming systems using only an ID card, security is compromised if the user's ID card falls into the hands of another person. Even if an ID card and password are used in combination, security is compromised if the user's ID card falls into the hands of another person who also learns the user's password. If only a password is used, then on the one hand security is compromised if another person learns the password, while on the other hand a user who forgets his or her password cannot obtain printed output.

### SUMMARY OF THE INVENTION

An object of the present invention is to provide an image forming system in which a user can have data printed by an image forming apparatus in a secure manner by registering biometric information at the user's information processing apparatus, without having to carry an ID card or remember a password.

The invented image forming system includes an information processing apparatus that sends print data over a communication network to an image forming apparatus which receives and temporarily stores the print data, and then prints the print data.

The information processing apparatus at the sending end includes:

a command input unit for receiving commands entered by a user;

a biometric information input unit for receiving reference biometric information entered by the user;

a computing unit for digitizing the reference biometric information;

a communication control unit for sending the print data and the digitized reference biometric information together to the image forming apparatus; and

an information memory unit for storing at least the print data and the digitized reference biometric information.

The image forming apparatus at the receiving end includes:

a communication control unit for receiving the digitized reference biometric information and the print data from the information processing apparatus;

an information memory unit for storing at least the print data and the digitized reference biometric information;

a print output unit for printing out the received print data;

a command input unit for receiving commands entered by the user;

a biometric information input unit for receiving confirmation biometric information entered by the user; and

a computing unit for digitizing the confirmation biometric information, comparing the digitized confirmation biometric information with the digitized reference biometric information to determine whether they represent the same individual, and passing the print data to the print output unit if the digitized confirmation biometric information and the digitized reference biometric information represent the same individual.

To print information in the secure mode, the user registers digitized biometric information for reference in an information processing apparatus equipped with a biometric information input unit. Afterward, when sending print data to an image forming apparatus, the information processing apparatus also sends the user's digitized biometric information for reference. The image forming apparatus, which also has a biometric information input unit, temporarily stores the received print data and the user's reference biometric information, and has the user reenter the biometric information for confirmation. The stored print data are printed if the biometric information entered for confirmation matches the reference biometric information. Accordingly, a user can protect sensitive printed information from prying eyes just by registering the user's own biometric information in the user's own information processing apparatus in advance, without having to carry an ID card or remember a password or the like.

### BRIEF DESCRIPTION OF THE DRAWINGS

In the attached drawings:

FIG. 1 is a block diagram illustrating an image forming system according to a first embodiment of the invention;

FIG. 2 illustrates the structure of print data sent from the information processing apparatus to the image forming apparatus for secure printing in the image forming system in FIG. 1;

FIGS. 3A and 3B form a flowchart illustrating the image forming method (operation) of the image forming system in FIG. 1;

FIG. 4 is a block diagram illustrating an image forming system according to a second embodiment of the invention;

FIG. 5 illustrates the structure of print data sent from the information processing apparatus to the image forming apparatus for secure printing in the image forming system in FIG. 4;

FIGS. 6A and 6B form a flowchart illustrating the image forming method (operation) of the image forming system in FIG. 4;

FIG. 7 is a block diagram illustrating an image forming system according to a third embodiment of the invention;

FIG. 8 shows an exemplary table of table of registration numbers stored in relation to the encryption keys stored in the encryption key memory unit of the image forming apparatus in the image forming system in FIG. 7;

FIG. 9 illustrates the structure of encryption key registration data sent from the information processing apparatus to the image forming apparatus in the image forming system in FIG. 7;

FIG. 10 illustrates the structure of registration number notification data sent (returned) from the image forming apparatus to the information processing apparatus in the image forming system in FIG. 7;

FIG. 11 illustrates the structure of print data sent from the information processing apparatus to the image forming apparatus for secure printing in the image forming system in FIG. 1;

FIGS. 12A and 12B form a flowchart illustrating the image forming method (operation) of the image forming system in FIG. 7;

FIG. 13 is a block diagram illustrating an image forming system according to a fourth embodiment of the invention;

FIG. 14 shows an exemplary table of table of registration numbers stored in relation to the digitized biometric data stored in the receiving end information memory unit of the image forming apparatus in the image forming system in FIG. 13;

FIG. 15 illustrates the structure of print data sent from the information processing apparatus to the image forming apparatus for secure printing in the image forming system in FIG. 13;

FIGS. 16A and 16B form a flowchart illustrating the image forming method (operation) of the image forming system in FIG. 13;

FIG. 17 is a block diagram illustrating an image forming system according to a fifth embodiment of the invention; and

FIGS. 18A and 18B is a flowchart illustrating the image forming method (operation) of the image forming system in FIG. 17.

### DETAILED DESCRIPTION OF THE INVENTION

Embodiments of the invention will now be described with reference to the attached drawings, in which like elements are indicated by like reference characters.

### First Embodiment

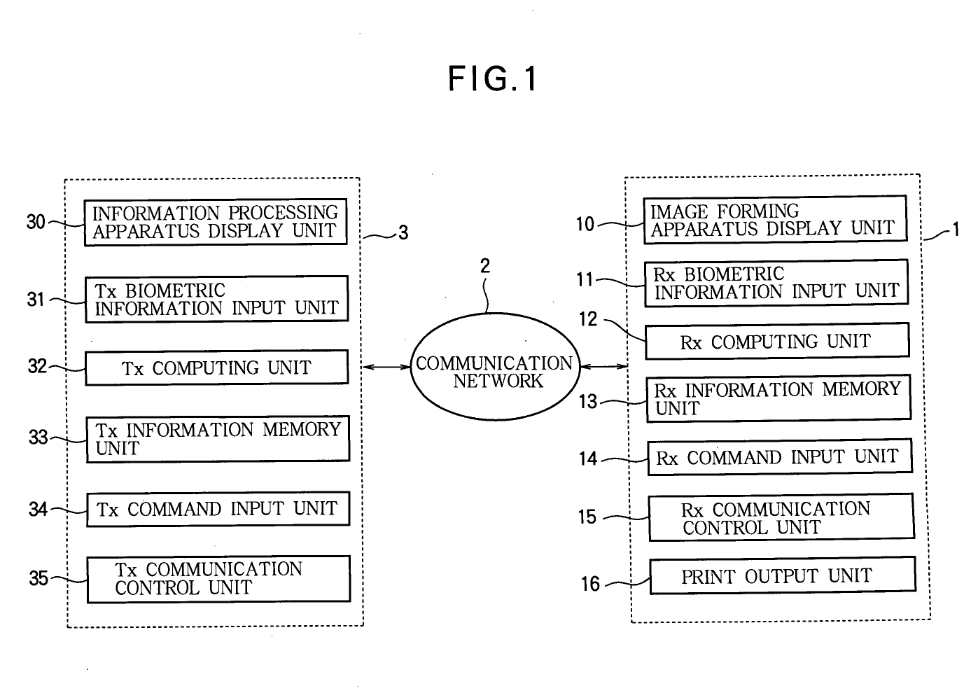

FIG. 1 is a block diagram illustrating an image forming system according to a first embodiment of the invention.

The image forming apparatus 1 receives print data (data used for printing) from a communication network 2, stores the print data temporarily in memory, and then prints out the print data. The communication network 2 may be, for example, a dedicated communication line, a telephone line, the Internet, a local area network (LAN), or any other type of network that (in general) connects a plurality of information processing apparatuses to one or more image forming apparatus 1. Nor is this embodiment limited to use of a communication network; the image forming apparatus and information processing apparatus may be interconnected by a long interface cable, such that documents printed by the image forming apparatus cannot be immediately retrieved. The information processing apparatus 3 is an apparatus in which print data are entered, and from which the user sends the print data over the communication network 2 to the image forming apparatus 1.

The information processing apparatus 3 comprises an information processing apparatus display unit 30 such as a display unit of a personal computer which displays details of operations being performed, status of these operations, and other such information, a sending end (Tx) biometric information input unit 31 which receives reference biometric information entered by a user, a sending end computing unit 32 which digitizes the fingerprint information (reference biometric information) entered by the user, prepares print data, and controls operation of the whole system including printing, a sending end information memory unit 33 which stores at least the print data and the digitized reference biometric information, a sending end command input unit 34 which receives details of the operations and commands entered by the user, including commands to send print data to the image forming apparatus 1, and a sending end communication control unit 35 which carries out interface and/or network processes for communication with the communication network 2 or image forming apparatus 1, including transmission of print data and digitized reference biometric information to the image forming apparatus 1.

Fingerprint information is the most commonly used type of biometric information and will be used in this embodiment, but the present invention may be practiced with any type of information used in biometric authentication or biometrics, including not only fingerprints but also iris patterns, handwriting or pen pressure, voiceprints, facial morphology, vein patterns in the hand, retinal capillary patterns, hand geometry (width, length, thickness), and so on.

The present invention detects fingerprint information by extracting change points of fingerprints. Examples of change points are the center of a convex pattern, the end of (break in) a convex pattern, a branch of a convex pattern, a delta at which convex patterns meet from three directions, and other points of change in the fingerprint pattern. About twenty to forty of these features are extracted from the image of a fingerprint to derive change point information, from which the relative positions of the change points, and the number, directions, relative positions, and intersections of the lines connecting them are converted to numerical values (digitized). Creating change point information from the fingerprint information and digitizing the change point information reduces the amount of fingerprint data. Another advantage is that the original fingerprint image cannot be reconstructed from the digitized change point information, making it difficult for a would-be fingerprint poacher to generate a fake fingerprint pattern.

Methods of detecting the fingerprint information include optical methods using a charge-coupled device (CCD) as a fingerprint image scanner, for example, and semiconductor methods. Some optical methods exploit the difference in refractive indices between a wet surface and dry surface of a prism, for example. When a slight amount of sweat adheres to the surface of a sensor, the refractive index of the sensor changes. The light reflected from the surface is imaged by a CCD camera to generate a black and white image representing the asperities in the fingerprint. In the semiconductor method, about 300×300=90,000 microelectrodes are provided under a rigid protective film on the surface of a fingerprint sensor. The amount of charge that accumulates on each electrode depends on the surface asperities of the finger that touches the surface. The differences in charge that accumulate on the electrodes are detected and represented as an image.

The other biometric authentication methods mentioned above, which use iris patterns, handwriting or pen pressure, voiceprints, facial morphology, vein patterns in the hand, retinal capillary patterns, hand geometry (width, length, thickness), etc. gather different data from different objects (eye, handwriting, face, hand), but the authentication method itself is similar in that the acquired data is imaged, change points or characteristic features in the object (characteristic parameters) are extracted from the image, and then an optimization process is carried out, based on pattern classification methodology (pattern recognition), to minimize the probability of error in the recognition algorithm (engine) through statistical processing and learning, so that the individual can be identified.

The sending end biometric information input unit 31 carries out a program (firmware) executed by the sending end computing unit 32, which comprises a microprocessor (CPU), for example, to receive and/or compare the fingerprint information entered by the user from a fingerprint scanner (not shown). The program is stored in a program storage region (not shown) of the sending end information memory unit 33. As a specific example of fingerprint information, change points in the fingerprint may be extracted in the sending end biometric information input unit 31 and converted to digital data.

The program storage region is a region in a hard disk drive (HDD), a read-only memory (ROM), or a re-writable non-volatile memory such as a flash memory that stores the program for acquiring the fingerprint information, as well as programs for overall control of the apparatus. The sending end information memory unit 33 also includes other types of memory, such as a temporary working memory for use during program execution, a parameter memory for storing various information, and a frame buffer memory for storing print data.

The image forming apparatus 1 comprises: a print output unit 16 for printing received print data; an image forming apparatus display unit 10 such as the liquid crystal display unit used on many printers to indicate what operation the printer is performing and report the status of the operation and other information; a receiving end (Rx) biometric information input unit 11 that receives confirmation biometric information entered by a user; a receiving end computing unit 12 that digitizes the confirmation biometric information entered by the user, compares it with the reference biometric information, has the print data printed out by print output unit 16 if the confirmation biometric information and the reference information represent the same individual, and performs other processes such as controlling the formation of the printed image and the operation of the apparatus as a whole; a receiving end information memory unit 13 that stores at least the print data and the reference biometric information; a receiving end command input unit 14 by which the user enters operating information and commands, including commands to have received print data printed by the print output unit 16; and a receiving end communication control unit 15 that carries out interface and/or network processing for communication with the communication network 2 or information processing apparatus 3, including reception of print data and digitized reference biometric information from the information processing apparatus 3.

To say that the confirmation biometric information and the reference biometric information represent the same individual means that the receiving end computing unit 12 in the image forming apparatus 1 determines that the confirmation biometric information entered at the image forming apparatus 1 matches the reference biometric information entered at the information processing apparatus 3. It should be appreciated that the information need not match exactly. A difference of a few percent, as might be caused by a slight injury to the user's fingertip or a difference in the way the fingerprint is scanned by the sensor, can also be considered a match.

The operation of the receiving end biometric information input unit 11 is similar to that of the sending end biometric information input unit 31. The receiving end computing unit 12 has a computing device such as a microprocessor (CPU) that executes a program for receiving and/or comparing the fingerprint information. The program is stored as firmware in a program storage region (not shown) in the receiving end information memory unit 13. Execution of this program causes the receiving end biometric information input unit 11 to receive the user's fingerprint information from a fingerprint scanner (not shown). More specifically, the receiving end biometric information input unit 11 obtains fingerprint information by, for example, extracting change points of the fingerprint and converting them to digital data as described above.

The program storage region in the receiving end information memory unit 13 is similar to the program storage region in the sending end information memory unit 33: a region in a hard disk drive unit, a ROM, or a re-writable non-volatile memory such as a flash memory, storing a program for acquiring fingerprint information and programs for overall control of the apparatus. The receiving end information memory unit 13 also includes other types of memory, such as a temporary working memory for use during program execution, a parameter memory for storing various information, and a frame buffer memory for storing print data.

The receiving end computing unit 12 carries out several image data processing tasks on image data processed at the image forming apparatus 1, such as compression, decompression, code conversion, encryption, decryption, and digitization of fingerprint information.

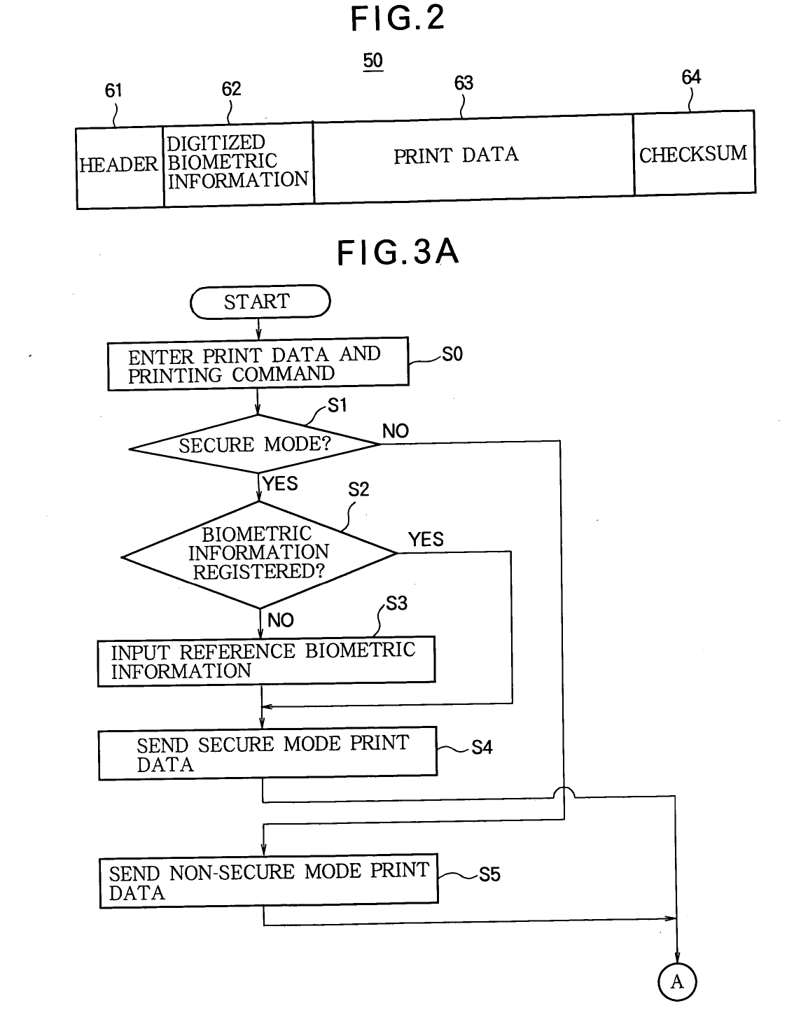

FIG. 2 illustrates the structure of the print data sent from the information processing apparatus to the image forming apparatus for secure printing in the image forming system in FIG. 1.

The print data stream 50 comprises a header 61, a digitized biometric information 62 containing digitized fingerprint information, a print data 63 which contains the image data to be printed, and a checksum 64 which confirms the integrity of the data. The header 61 identifies the content of the data and includes a code specifying secure mode printing or non-secure mode printing.

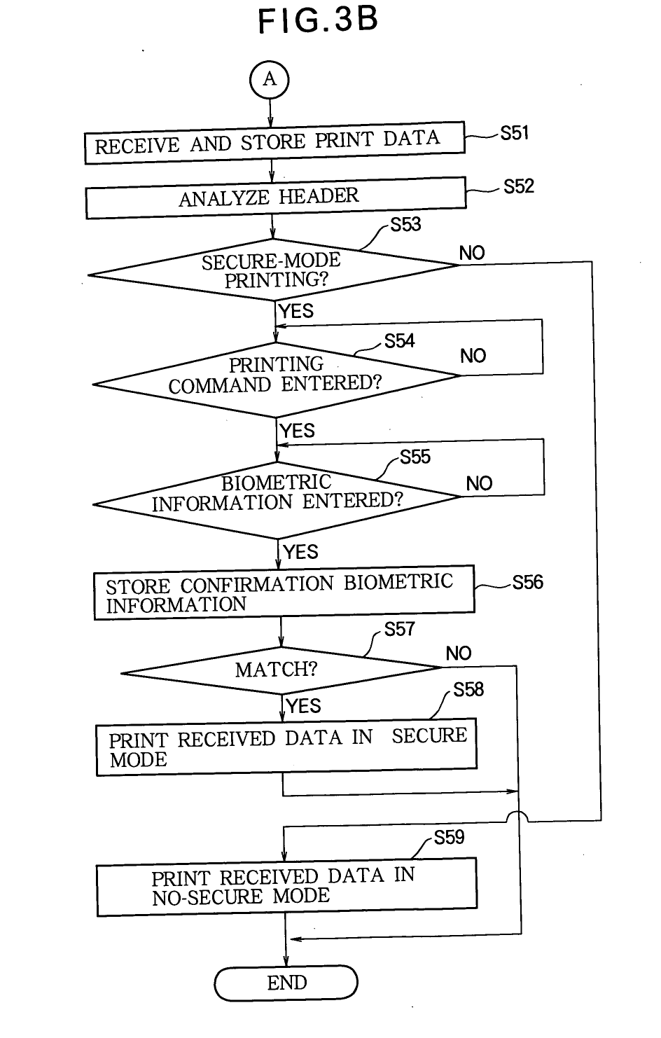

FIGS. 3A and 3B form a flowchart illustrating the image forming method (operation) of the image forming system in FIG. 1. To briefly summarize the method, the user enters print data and a printing command (S0 in FIG. 3A), causing the information processing apparatus 3 to send the print data to the image forming apparatus 1 via the communication network 2 (S4 or S5). The image forming apparatus 1 receives the print data from the communication network 2, temporarily stores the print data in a memory (S51 in FIG. 3B), and then prints out the print data (S58 or S59).

The transmission of the image data by the information processing apparatus 3 (S4 or S5) and the printing of the print data by the image forming apparatus 1 (S58 or S59) are carried out in one of two modes: a secure mode which prevents the printed matter from being seen by a person other than the user of the information processing apparatus 3, and a non-secure mode in which the printed matter can be seen by another person. The two modes involve different data processing steps.

In the information processing apparatus 3, first the sending end computing unit 32 determines whether the printing command entered in step S0 specifies secure mode printing or not (S1 in FIG. 3A). If the command specifies the secure mode (S1: Yes), whether reference biometric information (fingerprint information) has been registered or not is determined (S2). If fingerprint information is not registered yet (S2: No), the user inputs the fingerprint information for registration (S3). The fingerprint information in this embodiment is, for example, digitized by the sending end computing unit 32, and the digitized fingerprint information is stored in the sending end information memory unit 33.

When the fingerprint information has been registered, or if the fingerprint information has already been registered (S2: Yes), the print data to be printed in the secure mode are sent to the image forming apparatus 1 together with the fingerprint information (S4). In other words, a command to send the print data to the image forming apparatus 1 is entered (S0), and if the command specifies the secure mode (S1: Yes), the fingerprint information and the print data are sent to the image forming apparatus 1 (S4). If the command does not specify secure mode (S1: No), then the print data need not be printed in the secure mode and are sent to the image forming apparatus 1 without accompanying fingerprint information (S5).

The image forming apparatus 1 receives secure mode print data together with digitized reference biometric information, or non-secure mode print data without biometric information, from the information processing apparatus 3 and stores the data in the receiving end information memory unit 13 (S51 in FIG. 3B). The receiving end computing unit 12 analyzes the information included in the header in the received print data (S52), and determines if the printing command in the header specifies secure mode printing or non-secure mode printing (S53).

When the header does not specify the secure mode (S53: No), the received print data are immediately printed in the non-secure mode (S59). When the header specifies the secure mode (S53: Yes), whether a printing command for the received print data has been entered by the user at the receiving end command input unit 14 of the image forming apparatus 1 is determined (S54). The purpose of this step is to confirm that the user is near the image forming apparatus 1 and can take the printout without delay and without having the printed matter seen by another person.

If no printing command has been entered (S54: No), the process returns to step S54 to wait for the user to enter a command. When a printing command is entered (S54: Yes) whether confirmation fingerprint information has been entered or not is determined (S55). If confirmation fingerprint information has not been entered (S55: No), the process returns to step S55 to wait for the user to enter the confirmation fingerprint information. When the information is entered (S55: Yes), the information is digitized as confirmation biometric information and stored in the receiving end information memory unit 13 (S56).

The receiving end computing unit 12 retrieves the reference fingerprint information stored in the receiving end information memory unit 13 and the confirmation fingerprint information entered by the user, and compares them to determine whether they match, i.e., represent the same individual (S57). If the reference fingerprint information and the confirmation fingerprint information match (S57: Yes), indicating that the information was entered by the same individual (user), the data received in the secure mode print are printed (S58). If the information does not match (S57: No), indicating that the person who entered the printing command in step S54 is not the person who sent the secure mode print data, then the process ends.

As explained above, in this embodiment, a user's digitized biometric information is registered in advance in an information processing apparatus having an input unit for reference biometric information. When print data are sent to an image forming apparatus via a communication link, a secure mode printing command may be placed in the header and the user's reference biometric information may be sent together with the print data. An image forming apparatus having an input unit for confirmation biometric information analyses the secure mode printing command in the header and temporarily stores the print data and the user's reference biometric information. When the user enters confirmation biometric information via the biometric information input unit, the image forming apparatus compares the confirmation biometric information and the reference biometric information, and prints out the stored print data if the two items of information are determined to match. Therefore, the user does not have to carry an ID card, memorize a password, or register his or her own biometric information in the image forming apparatus in advance. The user only has to register his or her own biometric information in his or her own information processing apparatus in order to have desired print data printed by the image forming apparatus in the secure mode.

### Second Embodiment

In the security scheme in the first embodiment described above, printing is carried out only when confirmation biometric information matches reference biometric information. Even when entered by the same individual, however, the confirmation biometric information and reference biometric information may differ because of fingertip injuries or scanning glitches, as noted above. If the differences are too great, the user will not be authenticated, and will be unable to obtain secure mode printing. In the second embodiment, described next, another authentication means is used to augment the fingerprint information when fingerprint authentication fails.

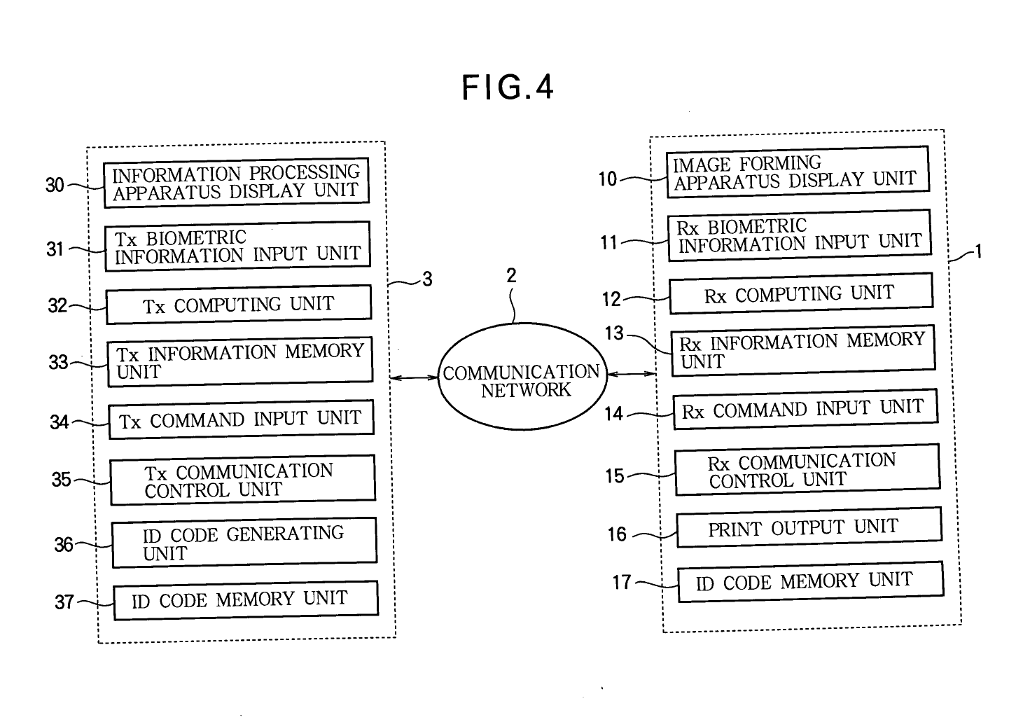

FIG. 4 is a block diagram illustrating an image forming system according to the second embodiment of the invention. The embodiment shown in FIG. 4 differs from the first embodiment shown in FIG. 1 in that the information processing apparatus 3 now also comprises an identification (ID) code generating unit 36 which generates an identification code similar to a conventional password, and an identification code memory unit 37 which stores the identification code. In an alternative configuration, the identification code is generated by the sending end computing unit 32 and stored in the sending end information memory unit 33. The identification code stored in the identification code memory unit 37 (or sending end information memory unit 33) of the information processing apparatus 3 is entered by the user from the sending end command input unit 34 and set by the identification code generating unit 36 (or sending end computing unit 32) before the user sends printing data. The sending end computing unit 32 sends the identification code together with the print data and the digitized reference biometric information from the sending end communication control unit 35 to the image forming apparatus 1.

The image forming apparatus 1 has an identification code memory unit 17 that stores the identification code received together with the print data. Alternatively, the receiving end information memory unit 13 may store the received identification code. When the reference biometric information and confirmation biometric information show at least a predefined degree of similarity, sufficient for the receiving end computing unit 12 to conclude that they might have been entered by the same individual, but do not match closely enough to indicate that this is definitely the case, the user is prompted to enter the identification code via the receiving end command input unit 14. If the identification code entered by the user matches the identification code received from the information processing apparatus 3, the stored print data are printed by the print output unit 16. Other components of this embodiment are similar to those in the first embodiment, so repeated descriptions will be omitted.

If, for example, the predefined degree of similarity mentioned above is 95% and the degree of similarity needed to conclude definitely that the same person entered both the reference biometric information and the confirmation biometric information is 99%, then the area from 95% to 99% is a ‘gray zone’ in which it is not certain whether the reference fingerprint information and the confirmation fingerprint information were entered by the same individual or different individuals. The boundaries of the gray zone can be set according to the input tolerance or variability of the fingerprint scanners at the image forming apparatus 1 and information processing apparatus 3, or from empirical statistics.

In this gray zone, in which the fingerprints are similar but not sufficiently similar for definite authentication, the further use of the identification code provides the extra degree of certainty needed to authenticate the user. The password-type identification code used as auxiliary authentication means in this embodiment can be replaced by another biometric authentication method such as one of the methods mentioned earlier.

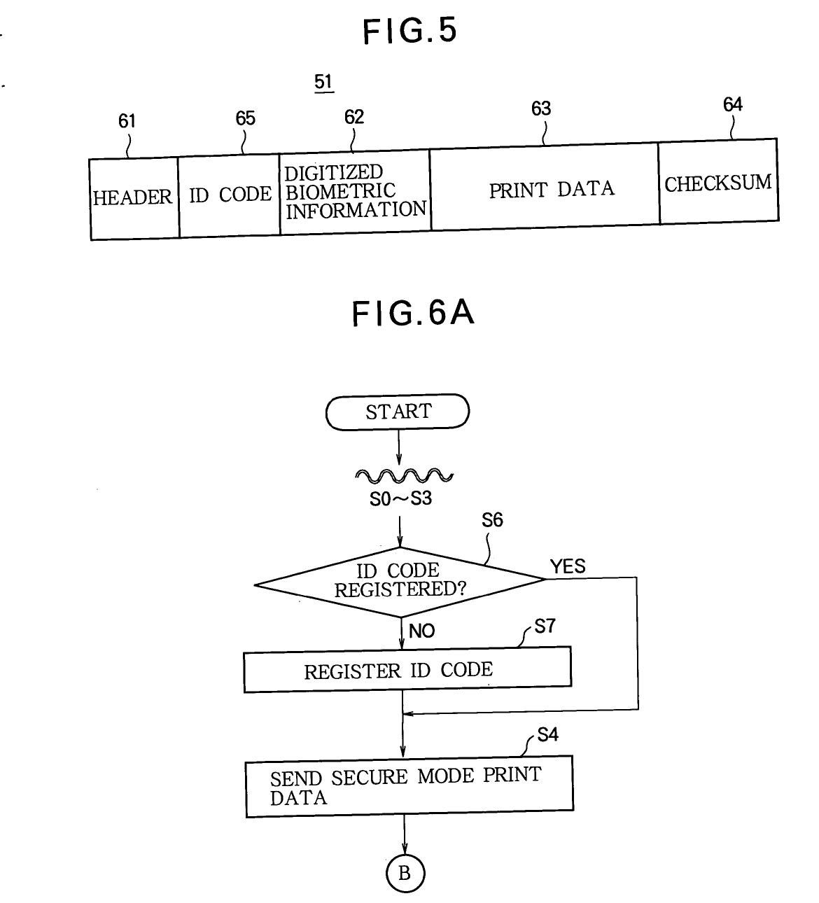

FIG. 5 illustrates the structure of print data sent from the information processing apparatus to the image forming apparatus for secure printing in the image forming system in FIG. 4.

The print data stream 51 of the second embodiment shown in FIG. 5 differs from the print data stream 50 of the first embodiment shown in FIG. 2 in having an identification (ID) code 65 disposed between header 61 and digitized biometric information 62. Other parts are similar to those in the first embodiment, so repeated descriptions will be omitted.

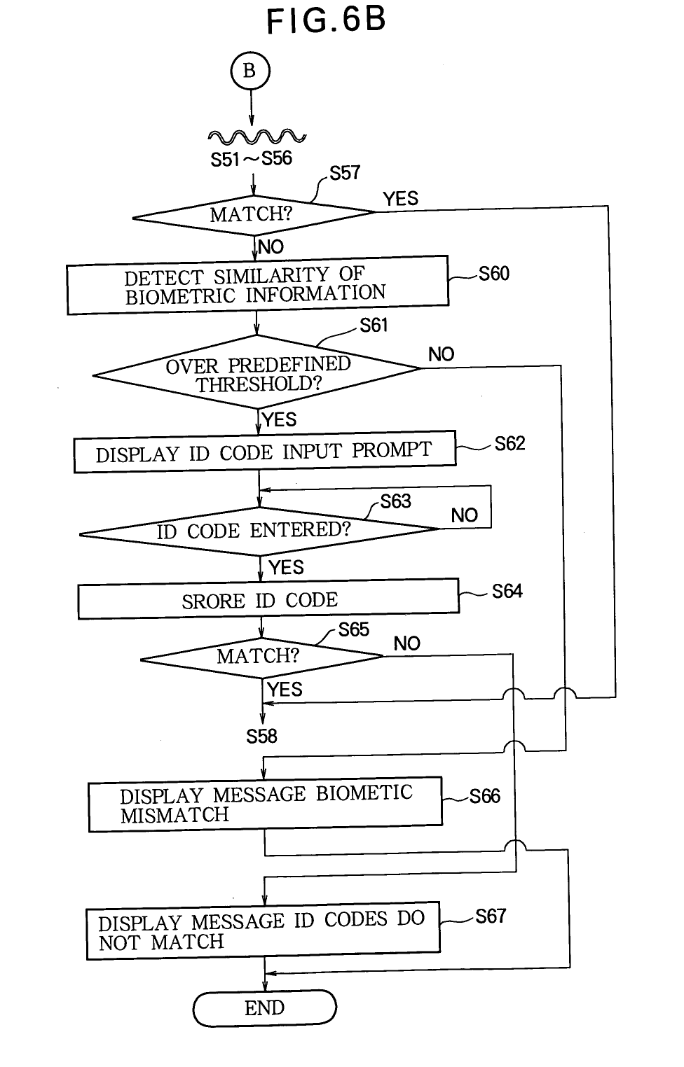

FIGS. 6A and 6B form a flowchart illustrating the image forming method (operation) of the image forming system in FIG. 4 in the secure printing mode. The steps that differ between this method and the method of the first embodiment will be described below; other steps will not noted only briefly.

The information processing apparatus 3 carries out steps S0 to S3 in FIG. 6A as described in the first embodiment. In the second embodiment, however, between steps S3 and S4, a new step is carried out to determine whether the user has already registered a reference identification code (S6). If the user has already registered an identification code (S6: Yes), the process proceeds to step S4, in which the identification code is sent together with the print data and reference biometric information. If the user has not yet registered an identification code (S6: No), the user is prompted by the identification code generating unit 36 (or sending end computing unit 32) to enter a reference identification code via the sending end command input unit 34, and the code is registered in the identification code memory unit 37 (S7). In step S4, the print data, the digitized reference biometric information, and the reference identification code are sent to the image forming apparatus 1.

The image forming apparatus 1 carries out steps S51 to S56 substantially as described in the first embodiment. In the second embodiment, however, the reference identification code is also received at step S51 and stored in the identification code memory unit 17 (or receiving end information memory unit 13). The receiving end computing unit 12 reads out the reference fingerprint information received from the receiving end information memory unit 13 and the confirmation fingerprint information entered by the user, and compares them to determine whether they match. They are now determined to match when they are at least 99% identical (S57 in FIG. 6B). If they match (S57: Yes), indicating that they were definitely entered by a same individual (user), the print data received in the secure mode are printed (S58). If the reference and confirmation fingerprint information do not match (S57: No), the similarity between them is determined (S60) and compared with the predefined threshold, e.g., 95% (S61).

When the similarity is less than the predefined threshold (S61: No), a message such as ‘Biometric mismatch’ is displayed on the image forming apparatus display unit 10, and the process ends. If the similarity equals or exceeds the predefined threshold (S61: Yes), a prompt such as ‘Enter your identification code’ is displayed on the image forming apparatus display unit 10 (S62). The receiving end computing unit 12 waits for an identification code to be entered (S63). When an identification code is entered (S63: Yes), the entered identification code is stored in the identification code memory unit 17 or receiving end information memory unit 13 (S64).

The receiving end computing unit 12 reads the reference identification code that was received from the information processing apparatus 3 and stored in the receiving end information memory unit 13 and the confirmation identification code that was entered by the user and stored in the identification code memory unit 17 (or receiving end information memory unit 13) and compares them to determine whether they match or not (S65). When the codes match (S65: Yes), this is taken to confirm that the reference and confirmation fingerprints were entered by the same individual (user), and the print data received in the secure mode are printed (S58). If the identification codes do not match (S65: No), a message such as ‘Identification codes do not match’ is displayed on the image forming apparatus display unit 10, and the process ends (S67).

As described above, in the second embodiment, when fingerprint authentication gives an ambiguous result, an identification code is used as an auxiliary authentication means to resolve the ambiguity. The correct user can thereby be authenticated and use the secure printing function of the image forming apparatus even when biometric authentication fails due to a fingertip injury or scanning discrepancy.

### Third Embodiment

The image forming systems of the preceding embodiments address the problem of verifying that the user who gave the printing command is present at the image forming apparatus before printing begins, but in some network environments it is also possible for the print data to be intercepted en route from the information processing apparatus 3 to the image forming apparatus 1 on the communication network 2. The third embodiment, described next, provides a secure method of printing even when such interception occurs.

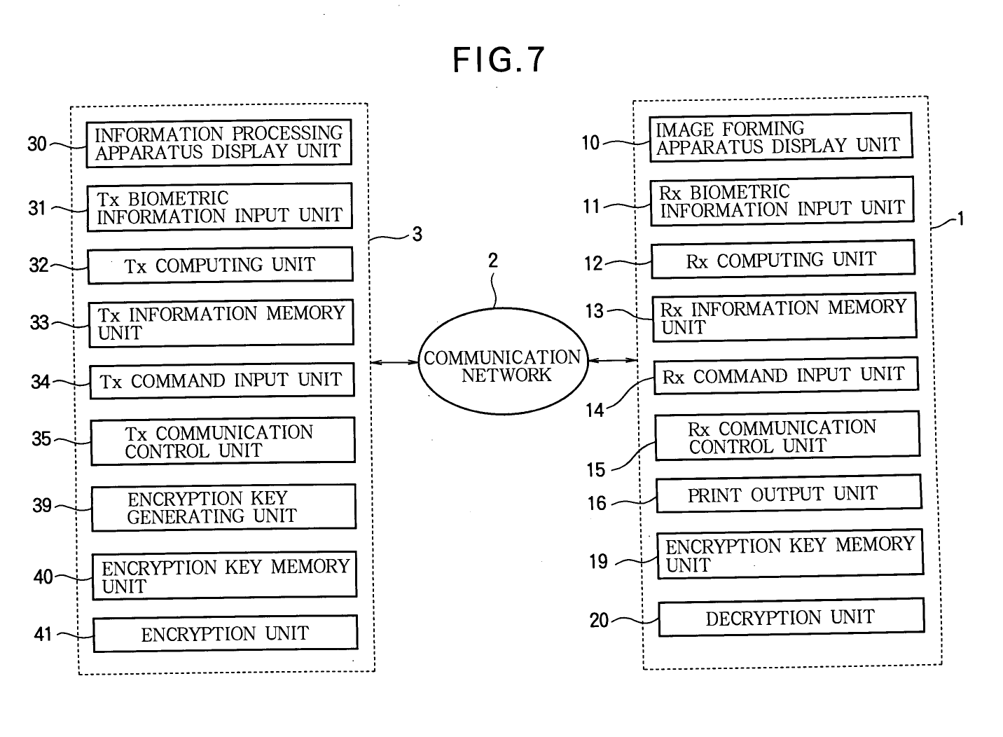

FIG. 7 is a block diagram illustrating an image forming system according to the third embodiment of the invention. The third embodiment differs from the first embodiment shown in FIG. 1 in that the information processing apparatus 3 in the third embodiment also has an encryption key generating unit 39 that generates an encryption key, an encryption key memory unit 40 that stores the encryption key, and an encryption unit 41 that uses the encryption key to encrypt the print data, so that the print data can be sent by encrypted communication. In an alternative configuration, the functions of the encryption key generating unit 39 and encryption unit 41 are carried out by the sending end computing unit 32, and the function of the encryption unit 41 by the sending end information memory unit 33.

Before the user uses the secure mode to send print data, the encryption key generating unit 39 (or sending end computing unit 32) generates the encryption key from the digitized reference biometric information in response to a command entered by the user via the sending end command input unit 34, stores the encryption key in the encryption key memory unit 40 (or sending end information memory unit 33), and has the sending end communication control unit 35 send the encryption key from the information processing apparatus 3 to the image forming apparatus 1.

The image forming apparatus 1 sends back a registration number indicating an address at which the encryption key is stored in the image forming apparatus 1. This registration number is stored in the encryption key memory unit 40 (or sending end information memory unit 33). When the user sends the print data, the print data are encrypted by the encryption key, and the encrypted print data, the stored registration number, and the digitized reference biometric information are sent to the image forming apparatus 1.

The image forming apparatus 1 has an encryption key memory unit 19 that stores the encryption key received from the information processing apparatus 3, and a decryption unit 20 that decrypts print data encrypted with the encryption key. When the image forming apparatus 1 receives data from the information processing apparatus 3, the receiving end computing unit 12 analyzes the header of the data to determine whether the data are print data to be printed in the non-secure mode, an encryption key to be registered for use in secure printing, or encrypted print data to be printed in the secure mode. When the received data are an encryption key to be registered, the encryption key and a unique registration number are stored in encryption key memory unit 19, and the registration number is sent to the information processing apparatus 3 in response. When the received data are encrypted print data to printed in the secure mode, the decryption unit 20 decrypts the print data by using the encryption key corresponding to a registration number that accompanies the print data.

In an alternative configuration, the encryption key memory unit 19 and decryption unit 20 are incorporated into the receiving end information memory unit 13 and receiving end computing unit 12, respectively. Other components are as described in the first embodiment, so repeated description will be omitted.

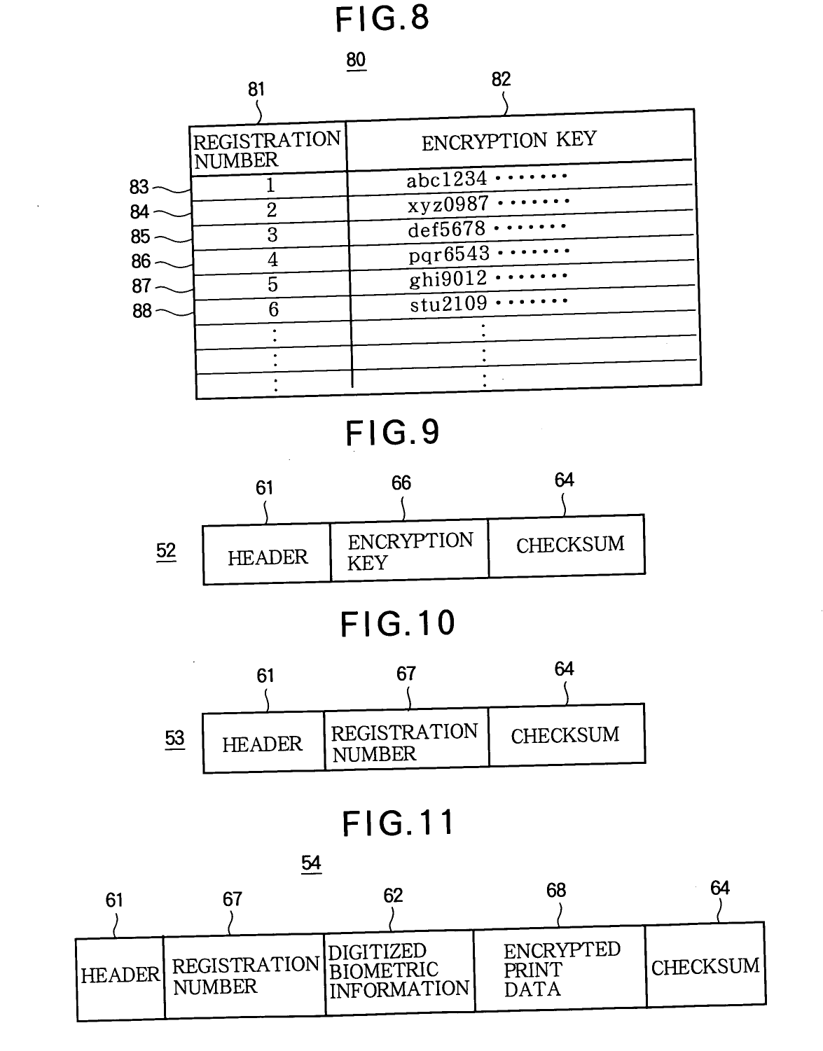

FIG. 8 shows an exemplary table of table 80 of encryption keys stored in the encryption key memory unit of the image forming apparatus in the image forming system in FIG. 7. The table 80 has a column 81 storing registration numbers, and a column 82 storing the corresponding encryption keys. Row 83 in table 80 stores registration number 1 and a first encryption key; rows 84, 85, 86, 87, and 88 store successive registration numbers and encryption keys. The first encryption key to be received is stored in the first row 83, the second encryption key to be received is stored in the second row 84, and so on. That is, the keys are registered in their order of reception and stored in the table 80 one-by-one, starting from the top row. If encryption key ‘abc1234 . . . ’ is received first, it is assigned registration number 1 and stored in row 83, column 82, while the registration number ‘1’ is stored in row 83, column 81 and sent to the information processing apparatus 3 as a registration address. Thereafter, whenever the image forming apparatus 1 receives encrypted print data accompanied by registration number ‘1’, this registration number is used as an index (registration address) to retrieve the encryption key ‘abc234 . . . ’ from the table 80, the print data are decrypted by use of the encryption key, and the decrypted print data are printed.

FIG. 9 illustrates the structure of encryption key registration data sent from the information processing apparatus to the image forming apparatus in the image forming system in FIG. 7.

The data stream 52 in FIG. 9 differs from the print data stream 50 of the first embodiment shown in FIG. 2 in that data stream 52 has only an encryption key 66 between the header 61 and checksum 64. The encryption key may be generated by any of various well-known methods, such as 3DES (Triple Data Encryption Standard), which is a symmetric encryption method employing block encryption, or RC4, which is a shared key method (algorithm) in which the length of the key can be altered.

Whereas the amount of information describing a fingerprint (the amount of numeric data representing its change points) is variable, most encryption schemes require an encryption key of a fixed length (e.g., 128 bits). The fingerprint information is therefore converted to a predefined number of bits by use of a general-purpose hash function (SHA-1). The hash value calculated by SHA-1 can be used as an encryption key in the RC4 data encryption algorithm to encrypt the print data at the information processing apparatus 3 and decrypt the print data at the image forming apparatus 1.

Detailed descriptions of the header 61 and checksum 64 will be omitted.

FIG. 10 illustrates the structure of the registration number notification data returned from the image forming apparatus to the information processing apparatus in the image forming system in FIG. 7. The data stream 53 shown in FIG. 10 differs from the print data stream 50 of the first embodiment shown in FIG. 2 in that data stream 53 has only a registration number 67 between the header 61 and checksum 64. The registration number indicates the storage position corresponding to the encryption key shown in FIG. 8. Detailed descriptions of the header 61 and checksum 64 will again be omitted.

FIG. 11 illustrates the structure of print data sent from the information processing apparatus to the image forming apparatus for secure printing in the image forming system in FIG. 7. The print data stream 54 in FIG. 11 differs from the print data stream 50 of the first embodiment, shown in FIG. 2, by including encrypted print data 68 instead of print data 63, and including the registration number 67 received from the image forming apparatus 1, interposed between the header 61 and digitized biometric information 62. Detailed descriptions of the header 61, digitized biometric information 62, and checksum 64 will be omitted.

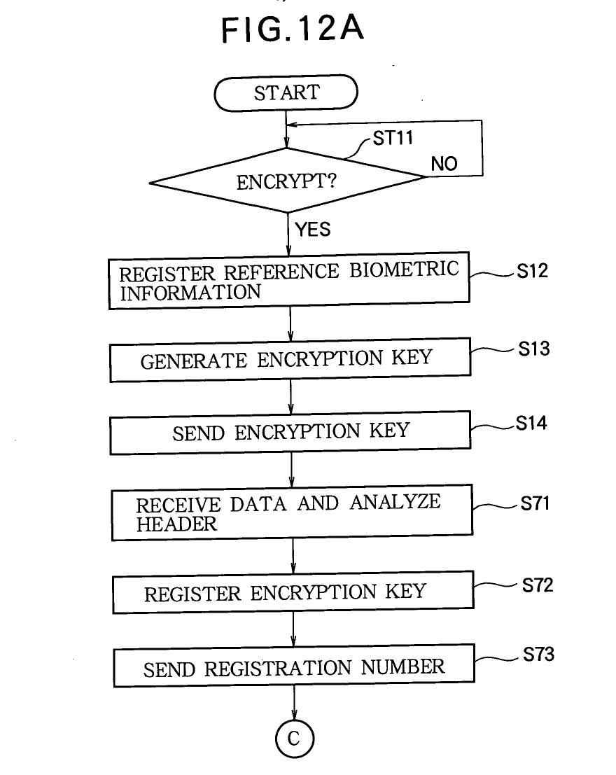

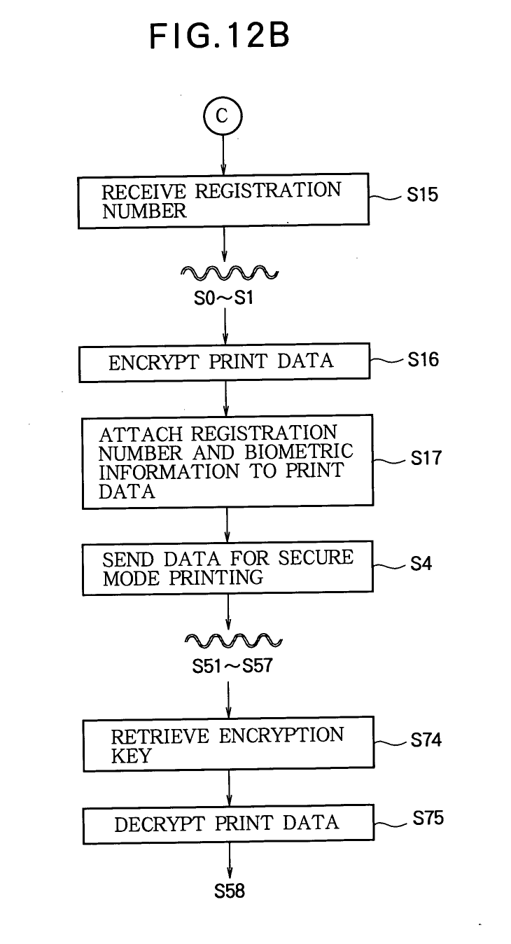

FIGS. 12A and 12B form a flowchart illustrating the image forming method (operation) of the image forming system in FIG. 7. The differences between this method and the method of the first embodiment will be described below. Steps similar to steps in the first embodiment will not be described, and the description will be confined to the steps necessary for printing in the secure mode.

Before sending print data to the image forming apparatus 1, the information processing apparatus 3 determines whether the print data must be encrypted for secure printing (S11 in FIG. 12A). When encryption is not required (S11: No), the process proceeds as described in the first embodiment, and the information processing apparatus 3 returns to step S11 to continue waiting for the need for encryption to arise. When encryption becomes necessary (S11: Yes), the reference fingerprint information (biometric information) is registered as described in the first embodiment (S12), and an encryption key is generated by the encryption key generating unit 39 (or sending end computing unit 32) in response to a command entered by the user via the sending end command input unit 34 (S13). A header including an encryption key registration command is added to the encryption key data, which are then sent from the sending end communication control unit 35 to the image forming apparatus 1 (S14).

The image forming apparatus 1 receives the data sent from the information processing apparatus 3 and analyzes the header to determine whether it includes a printing command for non-secure printing, a command to register an encryption key preparatory to secure printing, or a printing command for print data encrypted for secure printing (S71). When the header includes an encryption key registration command, the encryption key and its unique registration number (registration address) are stored as shown in FIG. 8 (S72), and the registration number is sent to the information processing apparatus 3 as a response (S73).

The information processing apparatus 3 receives the response including the registration number identifying the registration address of the encryption key from the image forming apparatus 1 and stores the registration number in the encryption key memory unit 40 (or sending end information memory unit 33) in relation to the corresponding encryption key (S15 in FIG. 12B). After these preparations, when the user has data to be printed in the secure mode, the information processing apparatus 3 carries out step S0 (input of print data and printing command) and step S1 (determining if the data should be printed in the secure mode) as described in the first embodiment, then encrypts the print data with the encryption key (S16). The registration number and the digitized reference biometric information are attached to the encrypted print data (S17), and sent to the image forming apparatus 1 as preparatory data for secure mode printing (S4).

The image forming apparatus 1 carries out steps S51 to S57 substantially as described in the first embodiment. In step S52 (FIG. 3B), the header is analyzed to determine whether the received data are to be printed in the non-secure mode, registered as an encryption key for subsequent secure mode printing, or decrypted and printed in the secure mode. When the data are to be decrypted and printed in the secure mode, after the user is authenticated by fingerprint scanning, the encryption key corresponding to the registration number is retrieved from encryption key memory unit 19 (or receiving end information memory unit 13) (S74). The encrypted print data are decrypted using the encryption key corresponding to the registration number (S75), and then printed (S58 in FIG. 3B).

As described, in the secure mode in this embodiment, print data to be sent from the information processing apparatus 3 to the image forming apparatus 1 are encrypted and sent with a registration number but without the encryption key. If the print data are intercepted en route to the image forming apparatus, decryption of the intercepted data is difficult because of the absence of the encryption key. Therefore, the printing security can be further enhanced.

### Fourth Embodiment

As described above, the image forming system in the third embodiment provides enhanced security in the event of data interception on the communication link by registering an encryption key in the image forming apparatus in advance, encrypting the print data by use of a conventional encryption scheme, and sending the encrypted print data together with a registration number that the image forming apparatus can use to retrieve the encryption key from its internal memory. Some conventional encryption schemes, however, including 3DSE or RC4, can be broken relatively easily with a powerful computer. Therefore in the fourth embodiment, described next, encryption is further enhanced by adding logic operations involving specific information to the conventional encryption method.

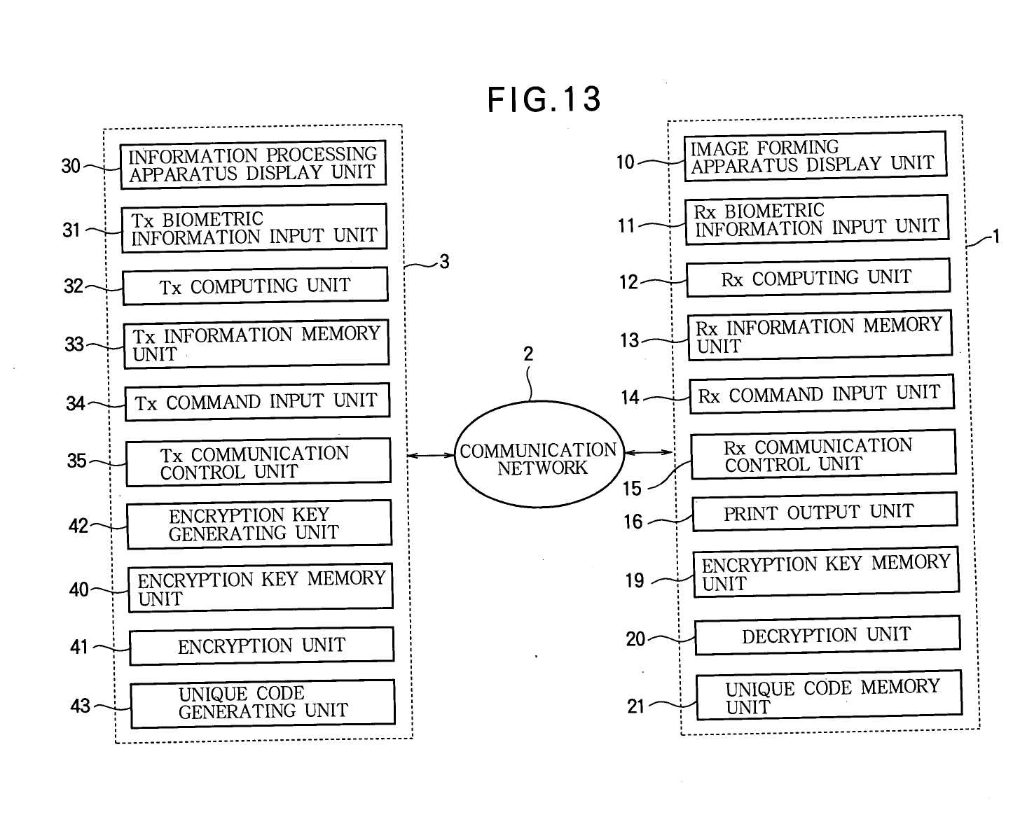

FIG. 13 is a block diagram illustrating an image forming system according to the fourth embodiment of the invention. The fourth embodiment differs from the third embodiment shown in FIG. 7 in that the information processing apparatus 3 of the fourth embodiment has a unique code generating unit 43 that generates a unique code based on the date, time, or a random number, and in that the encryption key generating unit 42 generates the encryption key from both the digitized fingerprint information and the unique code. Security is best enhanced if a different unique code is generated for each printing job, but other schemes may be employed. When one information processing apparatus sends print data to many different image forming apparatuses, for example, the unique code may be the serial number of the image forming apparatus.

The unique code generating unit 43 (or sending end computing unit 32) of the information processing apparatus 3 of the fourth embodiment generates a unique code by using, for example, a timer to generate the date and time, or a random number generator to generate a random number. From the digitized reference biometric information and the unique code, the encryption key generating unit 42 generates an encryption key to be used in encrypted communication. The encryption key memory unit 40 (or sending end information memory unit 33) stores the encryption key. When the user uses the sending end command input unit 34 to request the sending of print data to the image forming apparatus 1, the encryption unit 41 encrypts the print data using the stored encryption key.

The sending end computing unit 32 sends fingerprint information from the sending end communication control unit 35 to the image forming apparatus 1, then receives from the image forming apparatus 1 a registration number indicating the registration address of the fingerprint information in the image forming apparatus 1. In the secure printing mode, the print data are encrypted by use of the encryption key generated by the encryption key generating unit 42 from the fingerprint information and the unique code, and the print data are sent together with the registration number and the unique code to the image forming apparatus 1. The sending end information memory unit 33 stores the registration number of the biometric information, the unique code, and a program for generating the encryption key at the information processing apparatus 3 and the image forming apparatus 1.

The image forming apparatus 1 has a decryption unit 20 that decrypts print data encrypted with the encryption key. The receiving end computing unit 12 determines whether data received from the information processing apparatus 3 are print data to be printed in a non-secure mode, biometric information to be registered for use in printing in the secure mode, or encrypted print data to be printed in the secure mode. When the data are biometric information to be registered, the biometric information is stored in the receiving end information memory unit 13 under a specific registration number, and the registration number is sent in response to the information processing apparatus 3. When the data are encrypted print data to be printed in the secure mode printing, an encryption key is generated using the biometric information corresponding to the registration number and the unique code, and is used to decrypt the encrypted print data at decryption unit 20.

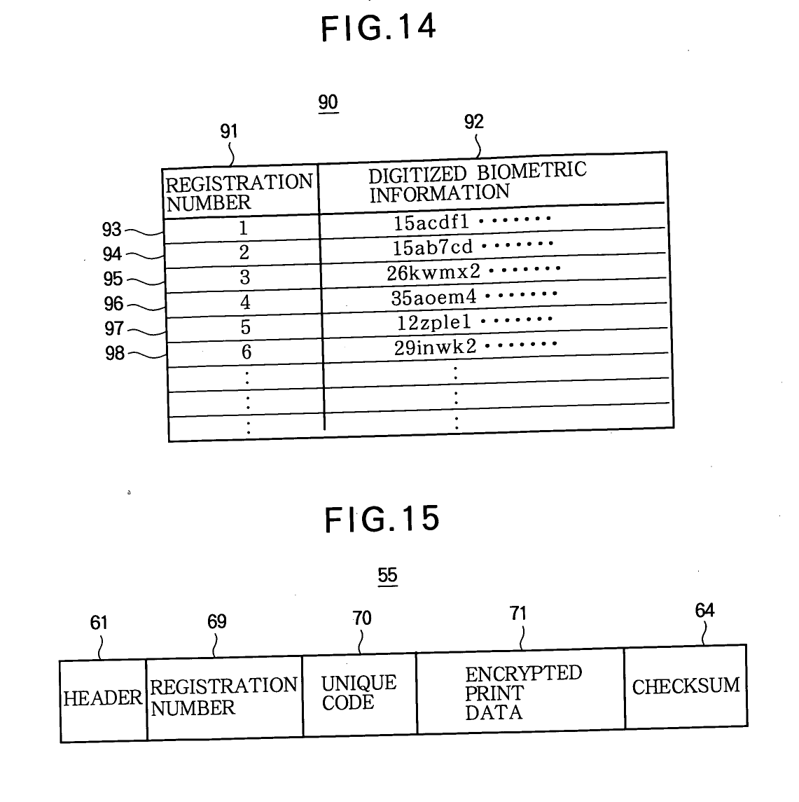

FIG. 14 shows an exemplary table of table 90 of digitized biometric data stored in the receiving end information memory unit of the image forming apparatus in the image forming system in FIG. 13. The table 90 has a column 91 storing registration numbers, and a column 92 storing the corresponding digitized biometric information. Row 93 stores registration number 1 and first digitized biometric information; rows 94, 95, 96, 97, and 98 store subsequent registration numbers and biometric information. The digitized biometric information is registered in the order of reception. If the digitized biometric information ‘15acdf1 . . . ’ is received first, it is assigned registration number ‘1’ and stored in the top row 93, and the registration number ‘1’ is sent as a registration address to the information processing apparatus 3.

When the image forming apparatus 1 receives encrypted print data accompanied by registration number (registration address) ‘1’, it retrieves the digitized biometric information ‘15acdf1 . . . ’ stored at the address corresponding to registration number ‘1’ and generates an encryption key from this information and the received unique code. Then it decrypts the encrypted print data using the encryption code and prints the decrypted data.

FIG. 15 illustrates the structure of print data sent from the information processing apparatus to the image forming apparatus for secure printing in the image forming system in FIG. 13.

The print data stream 55 in this embodiment shown in FIG. 15 differs from print data stream 54 of the third embodiment shown in FIG. 11 in that print data stream 55 has a unique code 70 instead of digitized biometric information 62 between the registration number 69 and encrypted print data 71. Furthermore, the registration number 69 indicates the registration address of digitized biometric information instead of the registration address of the encryption key as in the third embodiment. Also, the encrypted print data 71 is encrypted using an encryption key generated by a logic operation performed on the digitized biometric information and the unique code instead of an encryption key defined according to some encryption method in the information processing apparatus 3 as in the third embodiment. A detailed description of the header 61 and checksum 64 will be omitted.

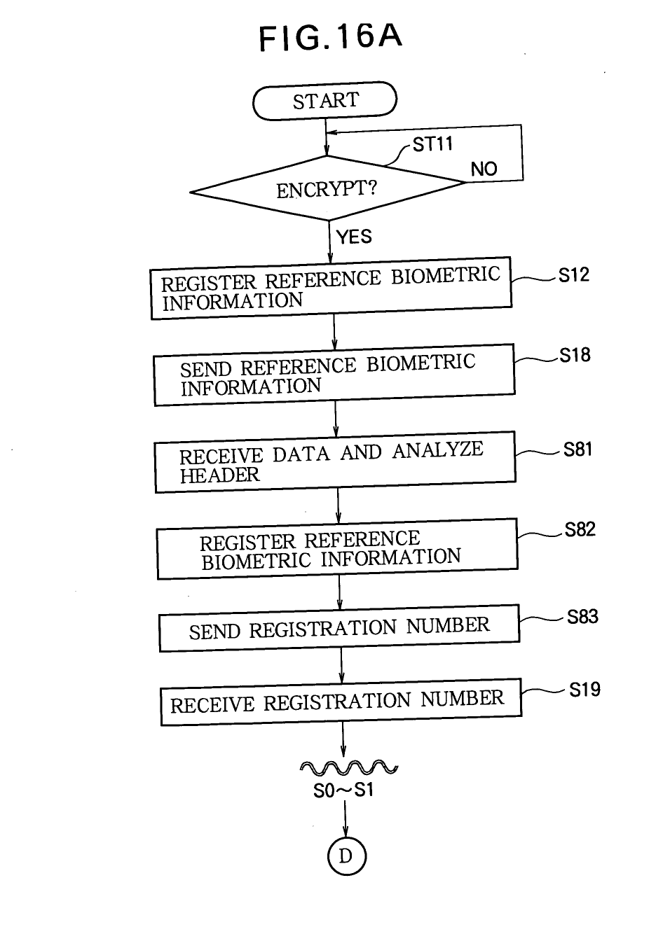

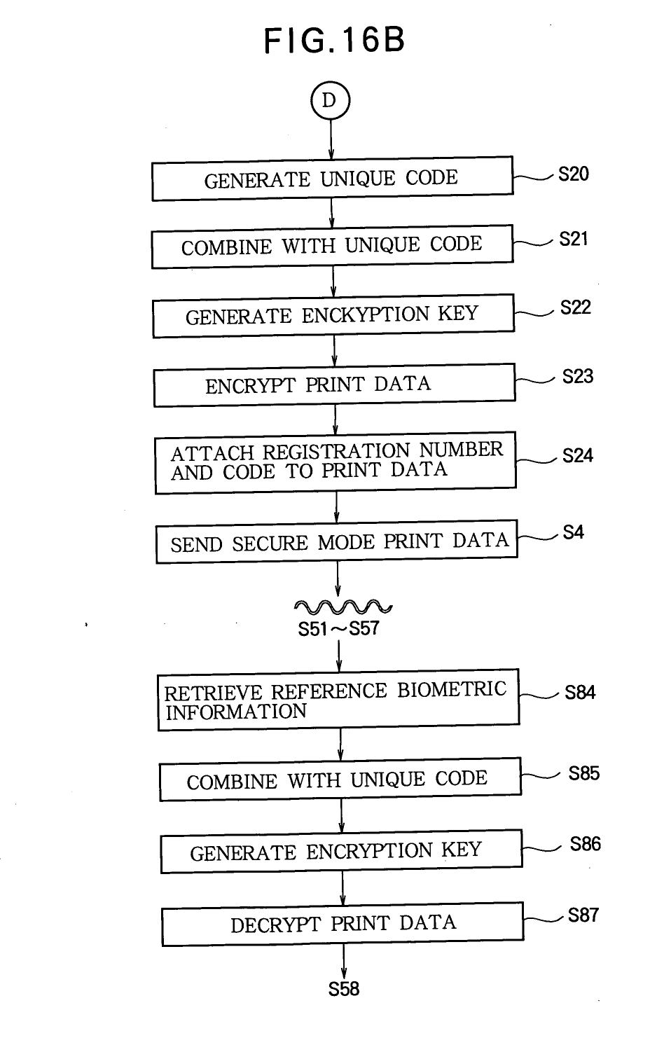

FIGS. 16A and 16B form a flowchart illustrating the image forming method (operation) of the image forming system in FIG. 13, showing only the steps that are used in the secure printing mode and differ significantly from the third embodiment. Other steps are similar to steps in the preceding embodiments and will not be described.

Before sending print data to the image forming apparatus 1, the information processing apparatus 3 determines whether the print data must be encrypted for secure mode printing (S11 in FIG. 16A). When encryption is not required (S11: No), the information processing apparatus 3 continues to wait as in the third embodiment. When encryption becomes necessary (S11: Yes), the reference fingerprint information (digitized reference biometric information) is registered as in the preceding embodiments (S12). A header including a biometric information registration command is added to the digitized biometric information, which is then sent from the sending end communication control unit 35 to the image forming apparatus 1 (S18).

The image forming apparatus 1 receives the data sent from the information processing apparatus 3 and analyzes the header to determine whether it includes a printing command for non-secure printing, a command to register reference biometric information preparatory to secure printing, or a printing command for print data encrypted for secure printing (S81). When the header includes a biometric information registration command, the biometric information and its unique registration number (registration address) are stored as shown in FIG. 14 (S82), and the registration number is sent to the information processing apparatus 3 as a response (S83).

The information processing apparatus 3 receives the response including the registration number identifying the registration address of the biometric information from the image forming apparatus 1 and stores the registration number in its encryption key memory unit 40 (or sending end information memory unit 33) in relation to the corresponding biometric information (S19). After these preparations, when the user has data to be printed in the secure mode, the information processing apparatus 3 carries out step S0 (input of print data and printing command) and step S1 (determining if the data should be printed in the secure mode) as in the first embodiment, and the unique code generating unit 43 generates a unique code for the user's printing job (S20 in FIG. 16B). Next, an encryption key is generated by performing a logic operation such as an exclusive OR operation, for example, on the stored biometric information and the unique code (S22), and the print data are encrypted by use of the encryption key (S23). The registration number and the unique code are attached to the encrypted print data (S24), a header specifying the secure mode is added, and the encrypted print data are sent as secure mode print data to the image forming apparatus 1 (S4).

The image forming apparatus 1 carries out steps S51 to S57 substantially as described in the first embodiment. In step S52 (FIG. 3B), the header is analyzed to determine whether the received data are to be printed in the non-secure mode, registered as reference biometric information for subsequent secure mode printing, or decrypted and printed in the secure mode. When the data are to be decrypted and printed in the secure mode, the user is authenticated by fingerprint scanning, using the reference biometric information stored in the receiving end information memory unit 13 in correspondence to the received registration number. This biometric information is then retrieved again from the receiving end information memory unit 13 (S84) and combined with the received unique code by performing a logic operation such as an exclusive OR operation (S85) to generate an encryption key (S86), which is temporarily stored in the encryption key memory unit 19. The encrypted print data are then decrypted using the encryption key (S87).

As described, in the secure mode in this embodiment, print data to be sent from the information processing apparatus 3 to the image forming apparatus 1 are encrypted and sent with a registration number but without the encryption key. The encryption key is generated by a logic operation performed on the biometric information and a unique code. If the print data are intercepted en route to the image forming apparatus, decryption of the intercepted data is even more difficult than in the third embodiment, because the encryption key keeps changing from job to job. Therefore, the printing security can be still further enhanced.

### Fifth Embodiment

In the description of the first to fourth embodiments above, it was assumed implicitly that the image forming apparatus had the necessary facilities for secure mode printing. However, some image forming apparatus connected to the communication network 2 may not provide such facilities. In the fifth embodiment, described below, an inquiry is made in advance from the information processing apparatus 3 to the image forming apparatus 1 to check whether the image forming apparatus 1 can operate in the secure mode. The fifth embodiment thereby avoids the inefficient sending of secure mode printing commands and attendant information to apparatus that does not support secure mode printing.

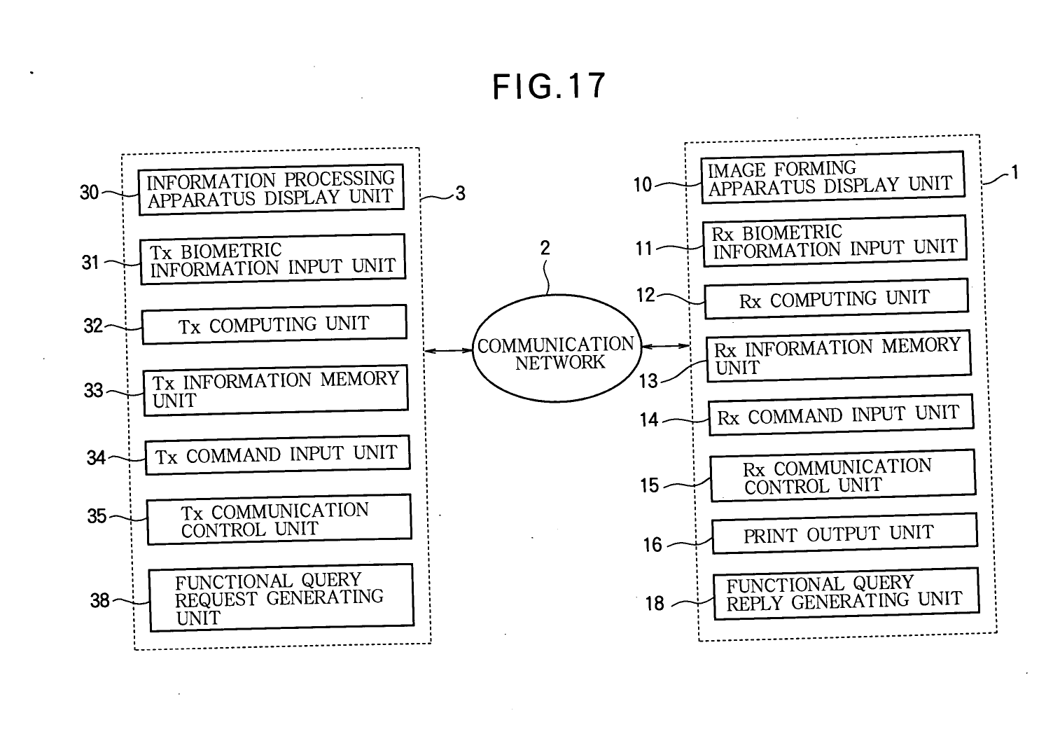

FIG. 17 is a block diagram illustrating the image forming system according to the fifth embodiment of the invention. The information processing apparatus 3 shown in FIG. 17 differs from the information processing apparatus 3 in the first embodiment shown in FIG. 1 by having a functional query request generating unit 38 that creates request data for inquiring whether the image forming apparatus 1 has capabilities for inputting biometric information and comparing it with received biometric information to determine whether the information comes from the same individual. Before sending print data in the secure mode, the sending end computing unit 32 has the sending end communication control unit 35 send this request data to the image forming apparatus 1 and determines from the reply from the image forming apparatus 1 whether the image forming apparatus 1 supports the secure mode of printing. If the image forming apparatus 1 supports the secure mode, the information processing apparatus 3 sends the print data together with reference biometric information as in the first embodiment.

The image forming apparatus 1 includes a functional query reply generating unit 18 that creates response data in reply to request data received from the information processing apparatus 3. When the receiving end computing unit 12 receives the request data through the receiving end communication control unit 15, it sends the response data generated by the functional query reply generating unit 18 through the receiving end communication control unit 15 to the information processing apparatus 3.

The information processing apparatus 3 has means (the information processing apparatus display unit 30) for displaying notification that the image forming apparatus does not accommodate the secure mode of printing when it is determined that the image forming apparatus 1 does not have the capabilities required for secure mode printing. When this message is displayed, the user is prompted to use the sending end command input unit 34 select the next operation, which may be to cancel printing, print in a non-secure mode, or transfer the print data to another image forming apparatus.

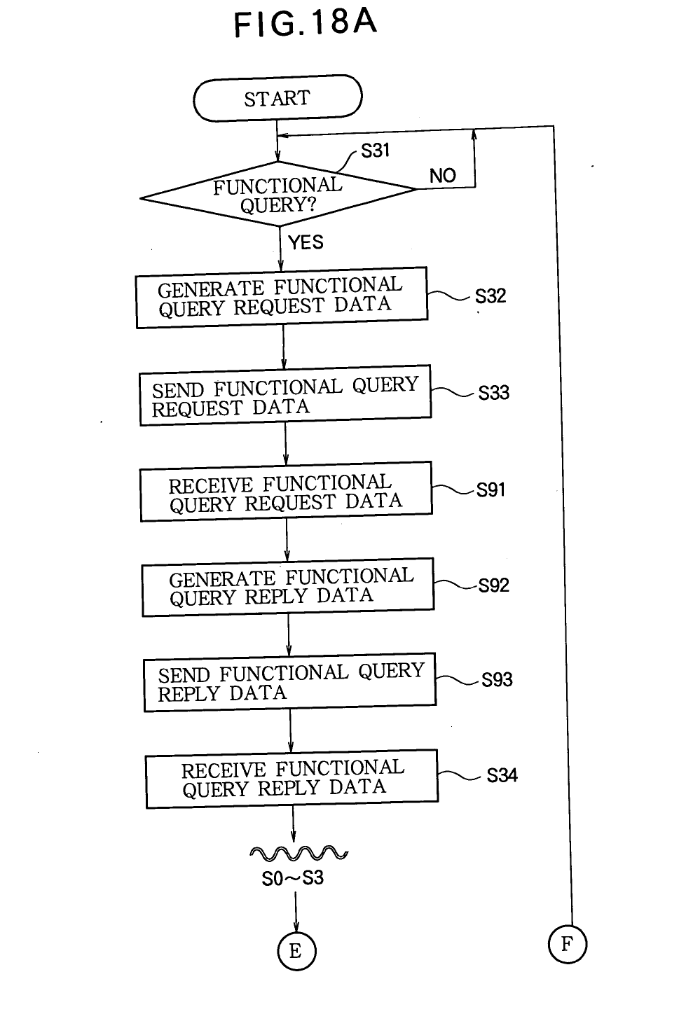

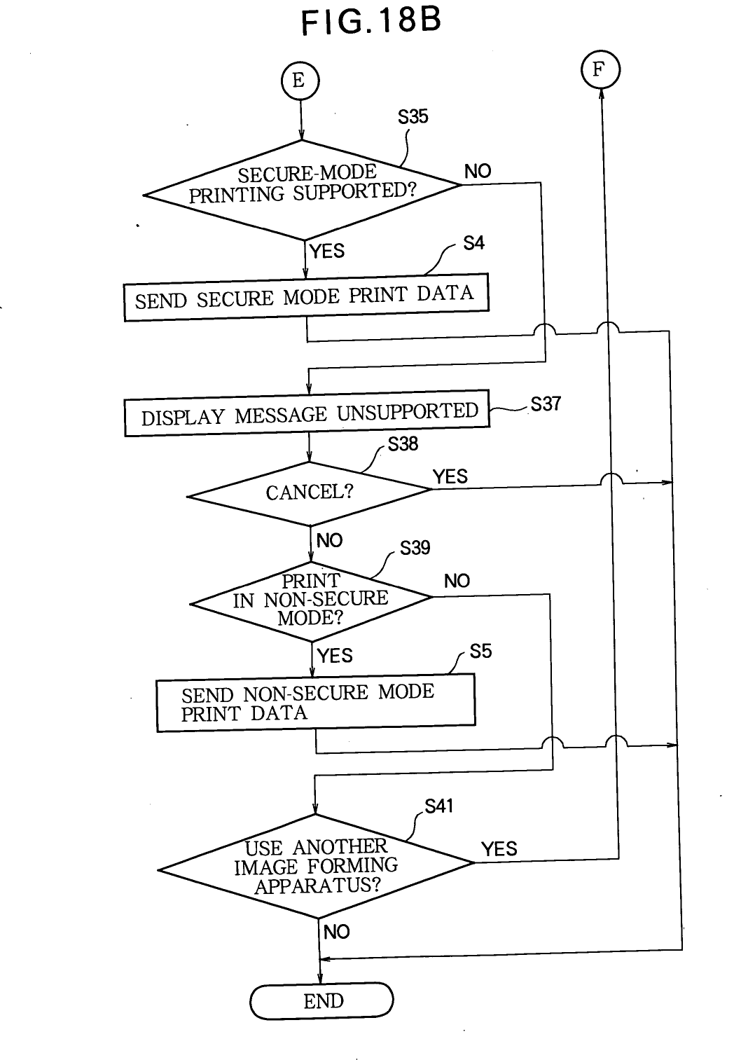

FIGS. 18A and 18B form a flowchart illustrating the image forming method (operation) of the image forming system in FIG. 17, showing only the steps that differ significantly from the first embodiment shown in FIGS. 3A and 3B. The steps that are similar to steps in the first embodiment will not be described.

The information processing apparatus 3 first decides whether to make an inquiry to check whether the image forming apparatus 1 has the capability to input biometric information and compare it with received biometric information to determine whether the information comes from the same individual (S31 in FIG. 18A). When no such inquiry is necessary (S31: No), processing proceeds normally and the information processing apparatus 3 continues to wait for the need for such an inquiry to arise. When an inquiry is necessary (S31: Yes), request data are generated (S32) and sent to the image forming apparatus 1 (S33) before print data are sent.

The image forming apparatus 1 receives the request data (S91), generates response data replying to the request data (S92), and sends the generated response data to the information processing apparatus 3 (S93).

The information processing apparatus 3 receives the response data from the image forming apparatus 1 (S34), and carries out step S0 (input of print data and printing command) and step S1 (determining if the data should be printed in the secure mode) as in the first embodiment. Before the user sends the print data, whether the image forming apparatus 1 supports secure printing or not is determined from the reply sent in step S93 from the image forming apparatus 1 (S35 in FIG. 18B). When it is determined that the image forming apparatus 1 supports the secure printing function (S35: Yes), the print data and reference biometric information are sent to the image forming apparatus 1 (S4).

If the image forming apparatus 1 does not support secure printing (S35: No), the information processing apparatus 3 displays a message on the information processing apparatus display unit 30 indicating that the image forming apparatus cannot print in the secure mode (S37). A decision is then made as to whether or not to cancel the printing job, according to input from the user (S38). If the user chooses cancellation (S38: Yes), the printing job is canceled. If the user does not choose cancellation (S38: No), a further decision is then made as to whether or not to carry out the printing job in the non-secure mode (S39). If the user chooses to execute the printing job in the non-secure mode (S39: Yes), the data necessary for printing in the non-secure mode are sent to the image forming apparatus 1 (S5). When the user chooses not to execute the printing job in the non-secure mode (S39: No), a still further decision is made as to whether to transfer the print data to another image forming apparatus (S41). If the user chooses not to transfer the print data to another image forming apparatus (S41: No), the printing job is canceled despite the user's earlier selection in step S38. If the user chooses to transfer the print data to another image forming apparatus (S41: Yes), the process returns to step S31, and a similar inquiry is sent to another image forming apparatus.

Although the above decisions are shown being made serially, the user may be presented with a menu of options, i.e., to cancel printing, print in the non-secure mode, or print by using another image forming apparatus, and prompted to select one of them.

As described above, the fifth embodiment makes provisions to confirm that the image forming apparatus 1 can carry out printing in the secure mode before the information processing apparatus 3 sends data to the image forming apparatus 1 in the secure mode. This avoids the efficiency of having the image forming apparatus 1 receive biometric information that it cannot process, and the possible embarrassment of having the image forming apparatus 1 print out the reference biometric information, or the annoyance of having the information processing apparatus 3 receive an error message from an image forming apparatus after sending secure-mode printing data.

The fifth embodiment was based on the first embodiment, but similar inquiry features can be added to the second, third, and fourth embodiments.

A few variations of the preceding embodiments have been mentioned, but those skilled in the art will recognize that further variations are possible within the scope of the invention, which is defined in the appended claims.

What is claimed is:

1. An image forming system in which an information processing apparatus sends print data to an image forming apparatus that receives and prints the print data, wherein:
the information processing apparatus comprises
a first biometric information input unit for entering reference biometric information,
a first computing unit for digitizing the reference biometric information, and
a first communication control unit for sending the print data and the digitized reference biometric information together to the image forming apparatus; and
the image forming apparatus comprises
a second communication control unit for receiving the digitized reference biometric information and the print data from the information processing apparatus,
a second information memory unit for storing the print data and the digitized reference biometric information,
a print output unit for printing out the received print data,
a second biometric information input unit for entering confirmation biometric information, and
a second computing unit for digitizing the confirmation biometric information, comparing the digitized confirmation biometric information with the digitized reference biometric information, and outputting the print data to the print output unit if the digitized confirmation biometric information and the digitized reference biometric information can be concluded to represent the same individual.

2. The image forming system of claim 1, wherein:
the information processing apparatus further comprises a first command input unit for input of a reference identification code;
the first communication control unit sends the identification code to the image forming apparatus together with the print data and the digitized reference biometric information;
the image forming apparatus further comprises a second command input unit for input of a confirmation identification code;
the second communication control unit in the image forming apparatus also receives the reference identification code from the information processing apparatus, together with the print data and the digitized reference biometric information,
when the second computing unit cannot conclude that the digitized confirmation biometric information and the digitized reference biometric information represent the same individual, the second computing unit compares the received reference identification code with the entered confirmation identification code and outputs the print data to the print output unit if the compared codes match.

3. The image forming system of claim 1, wherein:
the information processing apparatus further comprises a request generating unit for creating request data for inquiring whether the image forming apparatus has a secure printing capability,
the first communication control unit in the information processing apparatus sends the request data to the image forming apparatus and receives response data corresponding to the request data from the image forming apparatus,
the first computing unit in the information processing apparatus gives a secure printing command if the second computing unit decides, from the response data, that the image forming apparatus has the secure printing capability,
the image forming apparatus also has a reply generating unit for creating the response data corresponding to the request data sent from the information processing apparatus;
the second communication control unit in the image forming apparatus receives the request data from the information processing apparatus and sends the response data corresponding to the request data to the information processing apparatus; and
the second computing unit causes the reply generating unit to create the response data upon reception of the request data.

4. The image forming system of claim 3, wherein:
the information processing apparatus further comprises a display unit; and
when the first computing unit determines that the image forming apparatus does not have the secure printing capability, the first computing unit displays a warning on the display unit.

5. The image formation system of claim 1, wherein the biometric information is fingerprint information.

6. The image formation system of claim 5, wherein the first biometric information input unit and the second biometric information input unit extract change points of fingerprints.

7. An image forming system in which an information processing apparatus sends print data to an image forming apparatus that receives and prints the print data, wherein:
the information processing apparatus comprises
a first biometric information input unit into which reference biometric information is entered,
a first computing unit for digitizing the reference biometric information,
an encryption key generating unit for generating an encryption key from the digitized reference biometric information,
an encryption unit for encrypting the print data with the encryption key, and
a first communication control unit for sending the encryption key to the image forming apparatus, receiving from the image forming apparatus registration information indicating a storage location in which the encryption key is registered in the image forming apparatus, and sending the encrypted print data, the digitized reference biometric information, and the registration information together to the image forming apparatus; and
the image forming apparatus comprises
a second communication control unit for receiving the encryption key from the information processing apparatus, sending the registration information indicating the storage location in which the encryption key is registered to the information processing apparatus, and receiving the digitized reference biometric information, the registration information, and the encrypted print data from the information processing apparatus,
a second information memory unit for storing at least the encrypted print data, the digitized reference biometric information, the encryption key, and the registration information corresponding to the encryption key,
a decryption unit for decrypting the encrypted print data,
a print output unit for printing out the decrypted print data,
a second biometric information input unit for entering confirmation biometric information, and
a second computing unit for digitizing the confirmation biometric information, comparing the digitized confirmation biometric information with the digitized reference biometric information to determine whether they represent the same individual, and, if the digitized confirmation biometric information and the digitized reference biometric information can be concluded to represent the same individual, fetching the encryption key corresponding to the registration information received from the information processing apparatus from the second information memory unit, causing the decryption unit to decrypt the encrypted print data, using the fetched encryption key, and causing the print output unit to print the decrypted print data.

8. The image formation system of claim 7, wherein the biometric information is fingerprint information.

9. The image formation system of claim 8, wherein the first biometric information input unit and the second biometric information input unit extract change points of fingerprints.

10. An image forming system in which an information processing apparatus sends print data to an image forming apparatus that receives and prints the print data, wherein:
the information processing apparatus comprises
a first biometric information input unit into which reference biometric information is entered,
a first computing unit for digitizing the reference biometric information,
a unique code generating unit for generating a special code,
an encryption key generating unit for generating an encryption key from the digitized reference biometric information and the special code,
an encryption unit for encrypting the print data with the encryption key,
a first communication control unit for sending the digitized reference biometric information to the image forming apparatus, receiving from the image forming apparatus registration information indicating a storage location in which the digitized reference biometric information is registered in the image forming apparatus, and sending the special code, the registration information, and the encrypted print data together to the image forming apparatus; and
the image forming apparatus comprises
a second communication control unit for receiving the digitized reference biometric information from the information processing apparatus, sending the registration information indicating the storage location in which the received digitized reference biometric information is registered to the information processing apparatus, and receiving the special code, the registration information, and the encrypted print data from the information processing apparatus,
a second information memory unit for storing at least the encrypted print data, the digitized reference biometric information, the special code, and the registration information corresponding to the digitized reference biometric information,
a decryption unit for decrypting the encrypted print data,
a print output unit for printing out the decrypted print data,
a second biometric information input unit for entering confirmation biometric information, and
a second computing unit for digitizing the confirmation biometric information, comparing the digitized confirmation biometric information with the digitized reference biometric information, and, if the digitized confirmation biometric information and the digitized reference biometric information can be concluded to represent the same individual, fetching the digitized reference biometric information corresponding to the registration information received from the information processing apparatus from the second information memory unit, generating the encryption key from the fetched digitized reference biometric information and the received special code, causing the decryption unit to decrypt the encrypted print data, using the generated encryption key, and outputting the decrypted print data to the print output unit.

11. The image formation system of claim 10, wherein the unique code generating unit generates a different special code each time that printing processing is executed.

12. The image formation system of claim 10, wherein the biometric information is fingerprint information.

13. The image formation system of claim 12, wherein the first biometric information input unit and the second biometric information input unit extract change points of fingerprints.

14. The information processing apparatus of claim 1.

15. The information processing apparatus of claim 7.

16. The information processing apparatus of claim 10.

17. The image forming apparatus of claim 1.

18. The image forming apparatus of claim 7.

19. The image forming apparatus of claim 10.
